(19) United States
(12) Patent Application Publication
(10) Pub. No.: US 2026/0295623 A1
(43) Pub. Date: Oct. 1, 2026

(54) Gun Flush Box Control Mechanism

(71) Applicant: Ron Cradit, JR., Tyler, TX (US)

(72) Inventor: Ron Cradit, JR., Tyler, TX (US)

(21) Appl. No.: 19/092,089

(22) Filed: Mar. 27, 2025

(51) Int. Cl. B05B 15/55; B08B 3/08

(52) U.S. Cl. CPC B05B 15/55; B08B 3/08

(57) ABSTRACT

Disclosed herein is a gun flush box having a housing enclosing a plurality of cleaning enclosures, each having a lid adapted to accommodate a spray gun for cleaning purpose. A safety limit switch is installed in each of the cleaning enclosures, in a way that cleaning initiates only upon pressing the safety switch when the lid closes on the enclosures. A control centre, to initiate cleaning of one or more spray guns accommodated in the enclosures based on one or more modes. A turn knob to select a mode from a list includes a purge mode, a solvent flush mode, a last-docked gun mode, and a load mode, through a directional control valve for routing/directing a flow of waste material from each of the cleaning enclosures to a waste barrel.

### FIELD OF INVENTION

The present disclosure pertains to the field of cleaning devices and apparatuses and more particularly to a gun flush box control mechanism designed for the cleaning of spray guns used in various industries including automotive, marine, and other painting operations.

### BACKGROUND OF THE INVENTION

Paint spray guns are indispensable tools in industries like automotive and marine, where painting operations are routine. These equipment require efficient and thorough cleaning throughout their working cycle for their effective working. Typically, after each painting job, thorough cleaning of the spray gun becomes necessary to prevent color mixing, which could lead to undesirable color blends, and to prevent the buildup, blockage, and jamming of the equipment. In busy paint workshops where painting operations are conducted daily, frequent cleaning of multiple spray guns incurs significant time and expense.

There are spray gun washers available in the market that offer highly efficient cleaning of the spray guns. The most commonly used apparatus comprises a cabinet that includes a drain, a fluid supply, a fluid dispersion means, and a fluid collector. The fluid supply and fluid collector are consumables, brought to and removed from the machine. However, existing spray gun cleaning apparatuses must be cleaned periodically, which results in idle time for the operators and a spray gun may become inoperative in case the paint dries up. Further, the guns need to be dismantled before cleaning, which only a service engineer could do.

Regarding the aforementioned issues, patent document EP1574262B1 describes a spray gun cleaning apparatus comprising a structure and a cleaning tank removably mounted in the said structure. The tank has at least one outlet connected to a fluid supply. Further, the cleaning apparatus includes a perforated support arranged to support spray paint equipment in the tank during cleaning, a drain located beneath the perforated support connectable to a fluid reservoir, and at least one outlet having at least one nozzle, the nozzle being mounted in the tank to direct a cleaning fluid to objects to be cleaned in the tank, and an air extraction system.

The patent document U.S. Pat. No. 6,554,204 B1 describes a gun flush box controlled by a plural component proportioning unit. When a color change is desired, the operator places the spray gun in the flush box. The control system automatically triggers the gun to flush it with solvent, safely routing the flush material to a waste container. It also refills the lines with new color paint without wasting excess paint, and the system can handle two guns simultaneously. However, this document does not incorporate the cleaning of multiple guns based on different modes or settings.

The patent document U.S. Pat. No. 9,901,945 B2 describes a method for a system with multiple primary fluid sources and a common pump for fluid output. It involves halting the pumping of a first fluid, isolating the pump, connecting it to a solvent source and waste dump, and then cycling through pumping, recirculation, and flush modes. Subsequently, the pump is connected to a second primary fluid source, and pumping mode begins for a second fluid through the output line. However, this document does not include multiple cleaning processes for multiple guns simultaneously based on various modes or settings.

Therefore, there is a pressing demand for the advancement of a Gun

Flush Box that not only offers diverse cleaning modes for multiple spray guns but also incorporates intelligent features to automatically determine cleaning needs and adjust modes/settings accordingly. The proposed invention maximizes the efficiency and effectiveness of cleaning processes of painting equipment, thus reducing downtime and enhancing productivity.

### OBJECTIVES OF THE INVENTION

The principle objective of the present invention is to overcome the problems that occurred in the prior arts by streamlining the flushing process of spray guns.

An objective of the present invention is to ensure efficient and thorough cleaning to maintain optimal spray gun performance.

Another objective of the present invention is to provide a Gun Flush

Box that offers different modes for flushing spray guns, catering to various cleaning requirements.

Another objective of the present invention is to provide a gun flush box that offers simultaneous flushing/filling of multiple spray guns with paint during the painting process.

Another objective of the present invention is to optimize waste management and handling of dead paint residues during the flushing process, thus facilitating efficient waste disposal.

Yet another objective of the present invention is to reduce manual intervention and ensure thorough cleaning of paint guns, thereby minimizing downtime and maximizing operational efficiency.

### SUMMARY OF THE INVENTION

To achieve the above-mentioned objectives of the present invention, in one embodiment of the present invention, there is provided a Gun Flush Box.

According to an embodiment of the present invention, a gun flush box includes a housing having a plurality of cleaning enclosures, and each of the cleaning enclosures has a lid, such that each of the cleaning enclosures is adapted to accommodate a spray gun for cleaning. A safety switch is provided within each of the cleaning enclosures to initiate the cleaning of the spray guns, only upon the pressing of the safety switch when the lid closes on the enclosures. A control center configured to initiate the cleaning of one or more spray guns placed within said enclosures, as per one or more modes. The control center comprises a turn knob for selecting a mode from a list of modes including a purge mode, a solvent flush mode, a last-docked gun mode, and a load mode. Further, a directional control valve is installed in the housing to route a flow of the cleaning enclosures to a waste barrel connected to each of the cleaning enclosures based on the selected mode.

According to an embodiment of the present invention, in the said purge mode, the control center activates the directional control valve for directing the removal of solid paints from one or more spray guns to a designated waste barrel, intended for collecting the solid paints.

According to an embodiment, in the solvent flush mode, the control center activates the directional control valve to direct the clean paint solvents from one or more spray guns to another designated waste barrel, intended to collect the clean paint solvents.

In a further embodiment, in the last-docked gun mode, the control center activates the directional control valve of each of the spray guns for simultaneous cleaning of the residuals of the paint from each of the spray guns, to the designated waste barrels.

In another embodiment, the control center includes a selector mechanism for selecting the number of spray guns from the one or more spray guns required to be loaded with raw paint to initiate a painting process, in the load mode.

In another embodiment, upon selection of the spray guns, the control center supplies raw paint to the selected spray gun(s), for filling the spray gun(s) to initiate a painting process.

In another embodiment, the raw paint is supplied to the selected spray gun(s) via a pump installed in the housing.

In another embodiment, the control center is integrated with a timer unit that regulates switching of the plurality of modes, operation of the directional control valves, and filling of spray gun(s) with raw paint, in a pre-determined time.

Furthermore, in another embodiment, the control center includes a plurality of indicator lights and indicate activated modes and the number of active spray guns.

In another embodiment, the safety switch is a pneumatic switch.

In yet another embodiment of the gun flush box is to be utilized within a cleaning system.

In another aspect of the present invention, a method of cleaning one or more spray guns using a Gun Flush Box device is disclosed. The said method comprises the steps of placing one or more spray guns within the plurality of cleaning enclosures. Thereafter, the method includes the step to perform the closing of the enclosures securely using their respective lids having a safety limit switch mechanism, and initiating the cleaning process via a control center such that the cleaning process takes place based upon a selection of the one or more spray guns and one or more cleaning modes. However, the cleaning process initiates only after the closing of the lids of the cleaning enclosures, along with the safety limit switch mechanism in an actuated state.

In another aspect, the step of selecting the cleaning modes includes selection made from at least one of a purge mode, a solvent flush mode, a last-docked gun mode, a load mode, and a final shut-down mode.

In another aspect, the method includes a further step of directing a flow of waste materials from the cleaning enclosures to a waste barrel as per the selected mode, via a directional control valve.

In a further aspect of the method, the step of initiating comprises selecting the cleaning enclosures for cleaning via a turn knob.

### BRIEF DESCRIPTION OF THE DRAWINGS

FIG. 1 illustrates a front view of Gun Flush Box in accordance with an embodiment of the present disclosure.

FIG. 2 illustrates a perspective view of the Gun Flush Box of FIG. 1, in accordance with an embodiment of the present disclosure.

FIG. 3 illustrates a flow diagram of the method of cleaning one or more spray guns using the Gun Flush Box, in accordance with an embodiment of the present invention.

### DETAIL DESCRIPTION OF THE INVENTION

The embodiments herein and the various features and advantageous details thereof are explained more fully with reference to the non-limiting embodiments that are illustrated in the accompanying drawings and the following description. Numerous variations, changes, and substitutions may occur to those skilled in the art without departing from the invention. It should be understood that various alternatives to the embodiments of the present disclosure herein may be employed.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms used in this application, as all equivalents, synonyms, new developments, and terms or techniques that serve the same or a similar purpose are considered to be within the scope of the present claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

The present invention relates to a gun flush box that ensures efficient and thorough cleaning of paint-spraying guns and maintains optimal performance of spray guns by offering different modes for flushing spray guns as per cleaning requirements.

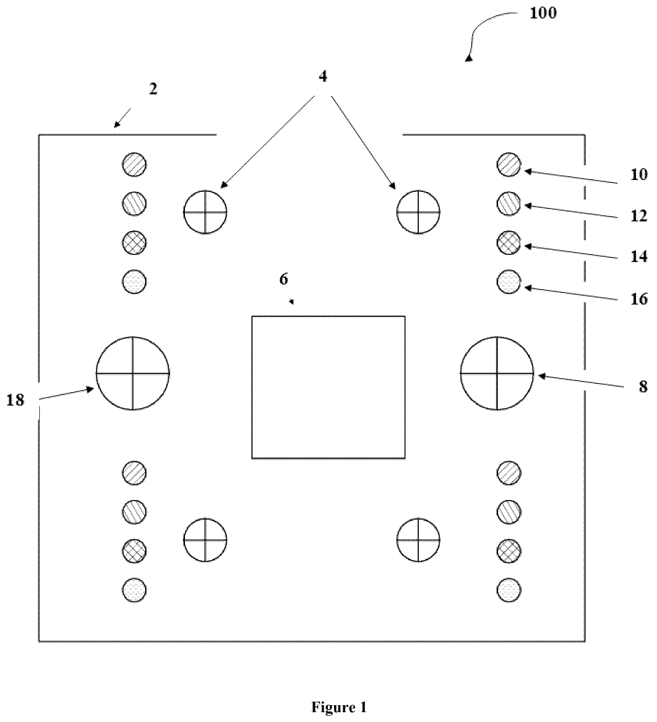

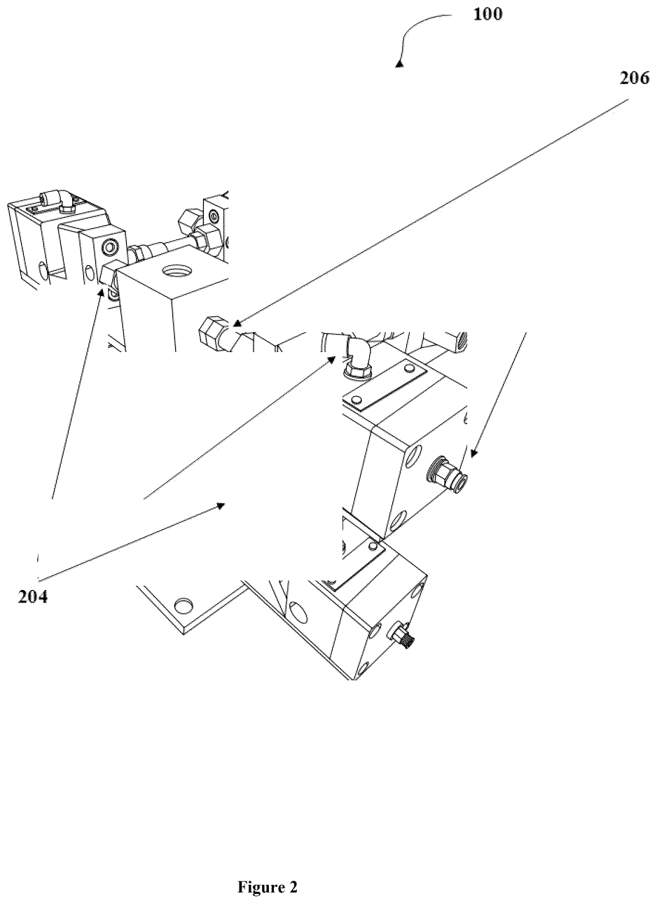

FIGS. 1 and 2 illustrate a gun flush box 100 for cleaning painting equipment such as painting guns or spray guns. In an embodiment, the gun flush box 100 includes a housing 2 that encloses a plurality of cleaning enclosures 4 and protects various components of the gun flush box 100. The housing 2 provides a secure and often modular environment for the internal components of the Gun Flush Box 100, to operate effectively and safely.

Each of the cleaning enclosures 4 is a hollow cylindrical-shaped entity and adapted to accommodate a spray gun for cleaning. Each of the cleaning enclosures 4 is provided with a lid that closes/covers the opening of each of the cleaning enclosures 4, after placing spray guns inside them, to initiate the cleaning operation of the spray guns.

The lid of each of the cleaning enclosures 4 includes a safety limit switch, which controls the initiation of the cleaning process. In an embodiment, the safety limit switch is a push-type button/press button that operates only when the lid is closed on the cleaning enclosures 4. In an embodiment, the safety switch is a pneumatic switch.

FIG. 1 further illustrates a front view of the control centre 6 of the gun flush box 100. The control centre 6 comprises a main panel in which multiple components are installed and adapted to perform a specific operation. The control centre 6 mainly refers to control circuitry that may include a processor module encoded with some smart logical algorithms. The control centre 6 is electrically paired with the safety limit switches to receive input from safety limit switches to initiate the cleaning operation.

In another embodiment, the control centre 6 may be a PLC controller that controls cleaning operations and performs activation/deactivation of the other components of the Gun Flush Box 100.

As the lid of cleaning enclosure 4 is closed by an operator, the safety switches are pressed, which leads to the activation of the control centre 6 which includes a display screen attached to the main panel to show a pop-up message/an alert to the operator for initiating the cleaning operation. In an embodiment, the display screen is an LCD (liquid crystal display) screen. In an alternative embodiment, the display screen is an HMI screen.

Further, the main panel of the control centre 6 is installed with a turn knob 8 which enables the operator to initiate the cleaning operation of the spray guns placed in the enclosures 4. The turn knob 8 is configured to select one or more modes of cleaning process from a plurality of cleaning modes/processes displayed on the display screen. In another embodiment, the modes of cleaning may include, but are not limited to, a purge mode, a solvent flush mode, a last-docked gun mode, a load mode, and a final shut-down mode.

Once, the cleaning mode is selected by the operator, the display screen of the control centre 6 shows an alert for selecting the number of spray guns to be cleaned. To select the spray guns, the main panel of the control centre 6 is equipped with a selector mechanism. In an embodiment, the selector mechanism consists of a selector button 18 that is pressed by the operator to select the number of spray guns required to be cleaned/loaded. Based on the selected mode and the number of spray guns, the control centre 6 activates a directional control valve installed in housing 2, configured to manage the cleaning process in each of the cleaning enclosures 4. The directional control valve includes multiple paint control valves 204 and solvent flush valves 206, (as shown in FIG. 2)

The directional control valve is configured to direct the flow of waste solid paints from the cleaning enclosure 4 into designated waste barrels that serve as a storage container for storing waste residues and clean solvent paints. In an embodiment, the direction control valve is a solenoid valve that aids in diverting the flow based on the selected cleaning mode.

In an embodiment, the Gun Flush Box includes an arrangement of a pump with a tripper plunger which is utilized for loading or refilling of the paint in the spray guns.

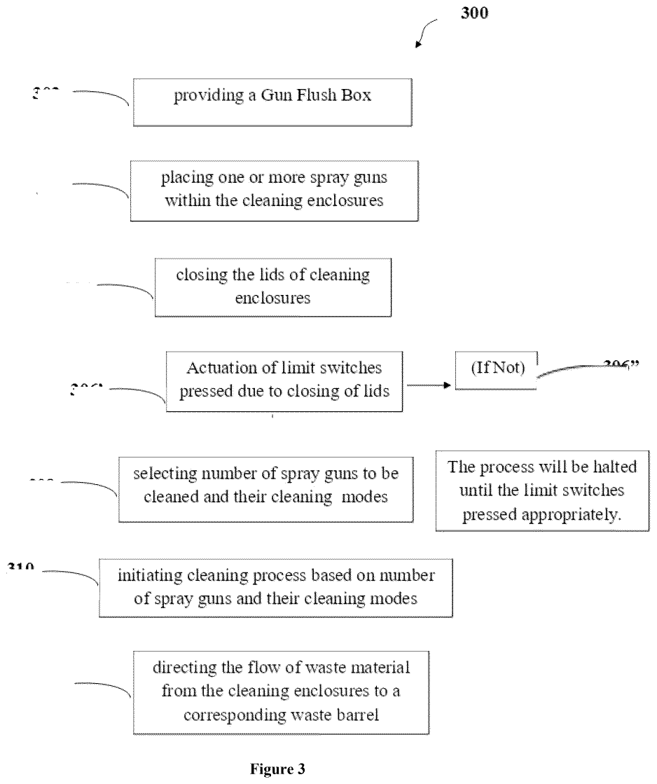

FIG. 3 illustrates a flow diagram describing a method 300 of cleaning one or more spray paint guns, in accordance with another aspect of the invention. In the first step 302, a Gun Flush Box 100 is provided. Said Gun Flush Box 100 includes multiple cleaning enclosures 4, each equipped with a lid and a safety limit switch that securely accommodates the spray guns. The safety limit switch ensures that the cleaning process can only be initiated when the lids are securely closed. In an alternate embodiment, a signal is sent to the control centre 6 indicating the spray guns are securely closed inside the Gun Flush Box 100, before starting any operation. The Gun Flush Box 100 further includes a control centre 6 that allows an operator to select one or more cleaning modes based on which a directional control valve controls the discharge of the flow of materials to and from the cleaning enclosures 4.

The next step 304 of the method involves placing one or more spray guns within the plurality of cleaning enclosures 4 with nozzles of the spray guns facing downwards. Further, the next step includes closing 306 the cleaning enclosures 4 securely using lids having a safety limit switch mechanism. In an alternative embodiment, the lids of the cleaning enclosure 4 are closed by squeezing two spring-loaded knobs together to allow the lid to close over the enclosure 4.

At Step 310, the method involves initiating the cleaning process, via a control center 6, based on a selection the one or more spray guns and one or more cleaning modes by the operator. The cleaning process is initiated only when the lids of each of the cleaning enclosure 4 are closed with the safety limit switch mechanism in the actuating state 306′. If the limit switches are not actuating 306″, the cleaning process gets halted. In another embodiment, step 310 of initiating includes step 308 of selecting, a turn knob, for each of the cleaning enclosures for cleaning.

The cleaning process is based on selected by the operator via the control centre 6 the number of spray guns to be cleaned and one or more cleaning modes. The cleaning process is initiated only upon the actuation 306′ of the safety limit switch, via the corresponding lid. In an alternate embodiment, the method displays an alert on the display screen when the operator selects a cleaning mode for a particularly cleaning enclosure 4 without securing the lid of said cleaning enclosure 4.

The above-disclosed cleaning modes are selected from at least one of a purge mode, a solvent flush mode, a last-docked gun mode, a load mode, and a final shut-down mode. Each mode addresses specific cleaning requirements. Once the cleaning of spray guns is accomplished, the next step 312 is directing the flow of waste material from the cleaning enclosure 4 to a waste barrel through the directional control valve, based on the selected mode. This ensures that the waste is properly disposed of while maintaining a clean work environment.

In one embodiment, the control centre 6 additionally allows for the selective management of each cleaning enclosure 4 by using a turn knob 8, this in turn allows the operator to have precise control over the cleaning process, facilitating the operation of multiple spray guns concurrently. Following are some examples of the operation of the Gun Flush Box 100 in different cleaning modes.

In an example, the operator selects the purge mode as the cleaning process and selects the number of one or more spray guns to be cleaned. The control centre 6 activates the directional control valve designated for cleaning enclosure 4 to direct the removal of solid paints from the gun to the designated waste barrel intended for collecting the solid paint residues. In said purge mode, the directional control valve remains open for approximately 30 seconds to direct the waste flow of solid paints to the designated waste barrel. The opening or closing of the directional control valve is controlled by a timer unit integrated into the control centre 6.

The timer unit determines the duration of operation of the directional control valves allowing them to switch between different cleaning modes, and loading the spray gun(s) based on the selected cleaning mode. The control centre 6 regulates the actuation of the directional control valve to switch to the next mode, i.e., the solvent mode. In another embodiment, control centre 6 directs the directional control valve to open for the last man out for an interval of around 30 seconds.

In another example, the operator selects the solvent flush mode as the cleaning mode for one or more spray gun(s). The control centre 6 activates the display screen to display the pressure of the directional control valve 206 of the corresponding cleaning enclosure 4, to direct clean paint solvents from one or more spray guns to another designated waste barrel, intended to collect the clean paint solvents. In the solvent flush mode, the directional control valve 206 remains open for the specific time duration of around 45 seconds, facilitating the flow of clean paint solvents, to the designated waste barrel. The control centre 6 monitors the timing of the directional control valve operation in the solvent flush mode and subsequently actuates the directional control valve to revert to the previous mode based on the detected time and then closes the Mixer Manifold paint flow valve 206. The control center 6 further validates the pressure on the mixer manifold until the pressure goes to “0” PSI via a pressure transducer for the other components in the Gun Flush Box. Once the pressure is validated, the control center closes the (IGF) Individual Gun Flush manifold paint valve 206 for the gun that is selected for the flushing paint load.

In an embodiment, the waste barrel designated for collecting clean paint solvent includes a recirculation means to reclaim the solvents or the distilled solvent back to a usable solvent for the next cycle.

In a preferred example, the operator selects the purge mode via the selector button of the control centre 6. Upon receiving the command, the control centre 6, automatically checks and stops all load paint operations for the Gun Flush Box 100.

Thereafter, the control center 6 verifies whether the waste barrel weigh scale is within pre-set operation limits. The control centre 6, upon detecting that the waste barrel is within 10% of the max 500 LBS limit, shows an alert on the display screen and signals the directional control valve to rotate to solids first for 30-second intervals for the selected gun placed in the cleaning enclosure 4. The control centre 6 then directs the directional control valve to rotate back to solvents for a time interval below 60 seconds. This in turn ensures all paints are purged and clean solvent is present.

In an embodiment, control centre 6 sends a signal to the direction control valve to remain closed so that the direction control paint valve 206 and the directional control solvent valve 204 do not stay open at the same time for a particular selection of spray guns.

In a further example, the operator selects the last-docked gun mode as the cleaning mode for the spray guns. The control centre 6 determines and activates the directional control valve of the cleaning enclosure 4 accommodated with the last spray gun for a pre-determined time. The same cleaning process as described in the above two modes is followed. After the last docked gun is cleaned, the control centre 6 activates the directional control valve of each of the cleaning enclosures 4 for a time interval of 15 seconds, for simultaneous cleaning of all the spray guns at once. Thereby, resulting in deep and thorough cleaning of all the spray guns. In an embodiment, the control centre 6 directs the directional control valve to be in an activated position for a time interval of around 60 seconds or maybe for a longer time interval.

In another example, the operator selects the load mode mode for one or more spray guns. The display screen of the control centre 6 notifies the operator to select the number of spray guns to be loaded. The operator, via the selector button 18 of the selector mechanism, selects the number of spray guns to be loaded with raw paint. The control centre 6 activates a pressure transducer installed in cleaning enclosures 4 to detect whether the relevant pressures of the paint drum and spray guns are within loading limits or not. Based on the detection, the control centre 6 validates the pressure on the mixer manifold via the pressure transducer for the other components of the Gun Flush box. Upon detecting and validating that the waste barrel is within 10% of the max 500 LBS limit, shows an alert on the display screen and signals the directional control valve to rotate to solvent first for 30-second intervals for the gun of selected cleaning enclosure 4. After the 30-second interval, the control centre 6 signals the directional control valve to rotate back to solids for a time interval which is below 60 seconds. This ensures all paints are purged and clean solvent is present.

Once all the paints are purged, the control center 6 opens the mixer

Manifold paint flow valve 206 and simultaneously opens the (IGF) Individual Gun Flush manifold paint valve 206 for the selected spray paint guns to be loaded. On actuation of the paint flow valve, the control center further actuates the tripper plunger installed in the Gun Flush Box 100 for pressurizing the paint within the selected spray guns through hoses, for a time interval of around 60 seconds. This in turn led to the loading of the spray guns with the paint.

In an embodiment, control centre 6 sends a signal to the direction control valve to remain closed to prevent both the direction control paint valve 206 and the directional control solvent valve 204 from being opened at the same time for a particular spray guns.

After all paints are purged, the control centre 6 directs the display screen to show that the loading operation has started and displays all the pressures relevant to the direction control valve operation for loading of paint.

Thereafter, control centre 6 activates a pump installed in the housing 2 to supply raw paint to the selected spray gun(s), for filling of the spray gun(s) to allow the painters to initiate the painting process.

The control centre 6 further includes a plurality of indicator lights 10, 12, 14, and 16 installed on the main panel of the control centre 6. After all of the spray guns are loaded or refilled with raw paint, the indicator lights 10, 12, 14, and 16 are activated to indicate the number of active spray guns and activated modes for each of the loaded guns. In an embodiment, the indicator lights 10, 12, 14, and 16 are designated specifically for each spray gun.

In yet another example, if the operator selects a Final Shut down mode via the display screen, then based upon the operator's selection, the control centre 6 first opens the directional control valve located on the high side of the waste barrel of the cleaning enclosures 4. After that control center 6 activates a wash shot for a time interval of around 3 seconds. Afterward, the control center 6 directs all the direction control valves to the Solvent drum. As the control centre 6 verifies the position of valves, it then opens and closes all directional control solvent valves 204 for a 3-second burst to ensure all passages and dead areas are clear and flushed. Once the required area is cleared, the control center 6 again activates the directional control valve for 3 3-second bursts of solvent on the drain manifold guns.

Furthermore, the control center 6 activates the air solenoids on the drum drain location valve simultaneously to wash the Teflon chemical valve out via rotation back and forth from solids paint to solvent. This in turn, shuts down the Gun Flush Box 100 with the display screen illustrating a green finish state and the leave spray gun trigger, until pressure shows “O” on the screen. If there is a malfunction in the paint valve 206 or solvent valve 204 that crates a continual run, then the display screen shows an alert warning. Furthermore, all the valves are set up to be in a closed position when the solenoid valves are deactivated. This in turn ensures an effective self-cleaning of the Gun Flush Box 100.

The technical effect achieved by the present invention is enhanced efficiency and safety in the flushing and loading processes of spray guns. By providing selectable modes and integrating a controller unit, the Gun Flush Box 100 offers improved control and automation, reducing manual intervention and minimizing the risk of accidents.

Various objects, features, aspects, and advantages of the inventive subject matter will become more apparent from the following detailed description of preferred embodiments, along with the accompanying drawing figures in which like numerals represent like components.

I/We claim:

1. A Gun Flush Box, comprising:
a housing encompassing a plurality of cleaning enclosures, each of said cleaning enclosures having a lid, wherein each of said cleaning enclosures is adapted to accommodate a spray gun for cleaning;
a safety limit switch installed in each of said cleaning enclosures, wherein the cleaning initiates upon the pressing of said safety switch when said lid closes on said enclosures.
a control center configured to initiate the cleaning of one or more spray guns housed within said enclosures based on one or more modes, wherein said control center comprises a turn knob to select a mode from a list of modes including a purge mode, a solvent flush mode, a last-docked gun mode, and a load mode,
wherein said housing comprises a directional control valve to route a flow of said cleaning enclosures to a waste barrel connected to each of said enclosures, based on a selected mode.

2. The gun flush box as claimed in claim 1, wherein in said purge mode, said control center activates said directional control valve to direct the removal of solid paints from said one or more spray guns to a designated waste barrel intended for collecting solid paints.

3. The gun flush box as claimed in claim 1, wherein in said solvent flush mode said control center activates said directional control valve to direct clean paint solvents from said one or more spray guns to another designated waste barrel intended to collect said paint clean solvents.

4. The gun flush box as claimed in claim 1, wherein in said last-docked gun mode said control center 6 activates said directional control valve of each of said spray guns for simultaneous cleaning the residual of said paint from each of said spray guns to said designated waste barrels.

5. The gun flush box as claimed in claim 1, said control center comprises a selector mechanism operated via a selector button for selecting a number of said spray guns from said one or more spray guns required to be loaded with raw paint to initiate a painting process.

6. The gun flush box as claimed in claim 5, wherein upon selection of said spray guns, said control center supplies raw paint to the selected spray gun(s) for filling of said spray gun(s) to initiate the painting process.

7. The gun flush box as claimed in claim 6, wherein said raw paint is supplied to said selected spray gun(s) via a pump installed in said housing.

8. The gun flush box as claimed in claim 1, wherein said control center 6 comprises a plurality of indicator lights to indicate an activated mode and the number of active spray guns in the enclosures.

9. The gun flush box as claimed in claim 1, wherein said control center is integrated with a timer unit to regulate switching of said plurality of modes, an operation of said directional control valves, and filling of said spray gun(s) with said raw paint.

10. The gun flush box as claimed in claim 1, wherein, the safety limit switch is a pneumatic switch.

11. A cleaning system comprising a Gun Flush Box as claimed in claim 1.

12. A method of cleaning one or more spray guns using a Gun Flush Box according to claim 1, said method comprising:
placing one or more spray guns within the plurality of cleaning enclosures and closing the enclosures securely using lids having a safety limit switch mechanism, and
initiating the cleaning process, via a control center, based on a selection of the one or more spray guns and one or more cleaning modes, wherein said cleaning process is initiated only upon the closing of each of the lids with the safety limit switch mechanism actuated.

13. The method of claim 12, wherein the cleaning modes are selected from at least one of a purge mode, a solvent flush mode, a last-docked gun mode, a load mode, and a final shut-down mode.

14. The method of claim 12, wherein the cleaning process further comprises directing, via a directional control valve, a flow of waste materials from the cleaning enclosures to a waste barrel based on the selected mode.

15. The method of claim 12, wherein the initiating comprises selecting, a turn knob, each of the cleaning enclosures for cleaning.
